(19) United States
(12) Patent Application Publication
(10) Pub. No.: US 2026/0230913 A1
(43) Pub. Date: Aug. 6, 2026

(54) WIRELESS TRANSMIT/RECEIVE UNITS AND METHODS ASSOCIATED WITH STEERING MODE RESTRICTIONS

(71) Applicant: InterDigital Patent Holdings, Inc., Wilmington, DE (US)

(72) Inventors: Rocco Di Girolamo, Laval (CA); Xavier De Foy, Kirkland (CA); Ulises Olvera-Hernandez, Saint-Lazare (CA); Saad Ahmad, Montreal (CA); Guanzhou Wang, Brossard (CA); Michelle Perras, Montreal (CA)

(73) Assignee: InterDigital Patent Holdings, Inc., Wilmington, DE (US)

(21) Appl. No.: 19/154,859

(22) PCT Filed: Feb. 9, 2024
(86) PCT No.: PCT/US2024/015134

§ 371 Date: Aug. 8, 2025

Related U.S. Application Data
(60) Provisional application No. 63/444,490, filed on Feb. 9, 2023.

(51) Int. Cl. H04W 28/02; H04W 72/21

(52) U.S. Cl. CPC H04W 28/0268; H04W 72/21

(57) ABSTRACT

Systems, methods, and instrumentalities are disclosed herein to support steering mode restrictions. A wireless transmit/receive unit (WTRU) may receive a first message from a network device, wherein the first message may indicate at least a first rule and a second rule for performing uplink transmissions associated with a protocol data unit (PDU) session across a first network access leg and a second network access leg. The WTRU may perform a first uplink transmission associated with the PDU session via at least one of the first network access leg or the second network access leg in accordance with the first rule. The WTRU may then determine that a condition for applying the second rule is satisfied and, in response to the determination, perform a second uplink transmission associated with the PDU session via at least one of the first network access leg or the second network access leg in accordance with the second rule.

### CROSS-REFERENCE TO RELATED APPLICATIONS

This application claims the benefit of Provisional U.S. Patent Application No. 63/444,490, filed Feb. 9, 2023, the disclosure of which is incorporated herein by reference in its entirety.

### BACKGROUND

A wireless communication system may support access traffic steering, switching, and splitting (ATSSS), but there may be a lack of flexibility in configuring ATSSS and/or allowing the use of ATSSS with restrictions.

### SUMMARY

Described herein are systems, methods, and instrumentalities associated with steering modes and steering mode restrictions (e.g., associated with splitting, switching, steering, and/or duplicating traffic across multiple access legs). According to embodiments of the disclosure, a wireless transmit/receive unit (WTRU) may receive a first message from a network device, wherein the first message may indicate at least a first rule and a second rule for performing uplink transmissions associated with a protocol data unit (PDU) session across a first network access leg and a second network access leg. The WTRU may perform a first uplink transmission associated with the PDU session via at least one of the first network access leg or the second network access leg in accordance with the first rule. Subsequently, the WTRU may determine that a condition for applying the second rule is satisfied and, in response, perform a second uplink transmission associated with the PDU session via at least one of the first network access leg or the second network access leg in accordance with the second rule.

In examples, the first rule may indicate a first manner for steering, switching, splitting, or duplicating the uplink transmissions associated with the PDU session across the first network access leg and the second network access leg, and wherein the second rule may indicate a second manner for steering, switching, splitting, or duplicating the uplink transmissions associated with the PDU session across the first network access leg and the second network access leg. In examples, the first rule may further indicate a validity condition for the first rule, the second rule may further indicate a validity condition for the second rule, and the condition for applying the second rule may be deemed satisfied in response to determining that the validity condition for the second rule is satisfied.

In examples, the validity condition for the first rule or the second rule may be associated with a time at the WTRU, a location of the WTRU, an orientation of the WTRU, a power (e.g., power level or power state) of the WTRU, a traveling speed of the WTRU, a quality of experience (QoE) measurement associated with the WTRU, or a transmission mode of the WTRU.

In examples, the WTRU may transmit a second message to the network device, which may indicate that the WTRU is switching to applying the second rule. In examples, the WTRU may further transmit a session establishment request associated with the PDU session to the network device and the first message may be received as a part of a PDU session establishment response from the network device. The session establishment request may indicate a preference of the WTRU for at least one of the first network access leg or the second network access leg.

In examples, the first network access leg described herein may be associated with a first cellular communication network and the second network access leg described herein may be associated with a second cellular communication network.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating examples of service data flows (SDF) associated with multiple access legs.

FIG. 3 is a diagram illustrating an example of a steering mode policy.

FIG. 4 is a diagram illustrating examples operations that may be performed by a WTRU to support steering mode restrictions.

FIG. 5 is a diagram illustrating example operations that may be performed by network devices (e.g., a user plane function) to support steering mode restrictions.

FIG. 6 is a diagram Illustrating example operations associated with applying steering mode rules and steering mode restrictions.

### DETAILED DESCRIPTION

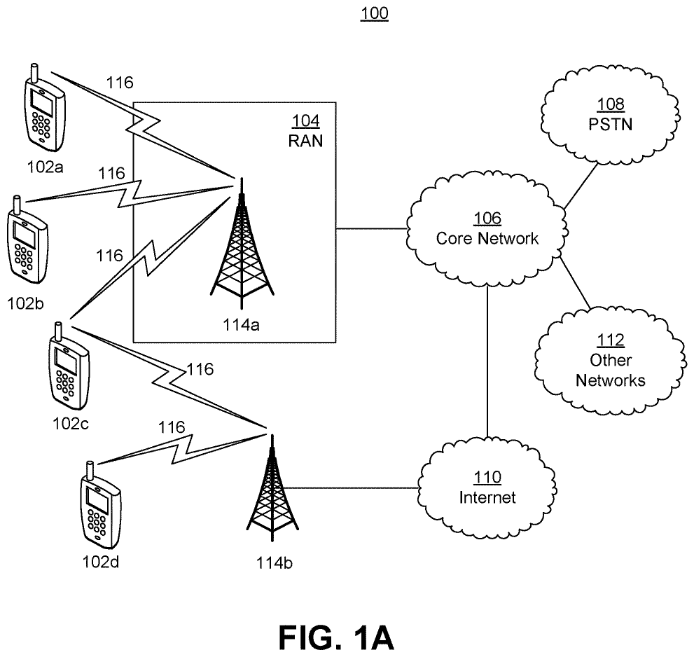

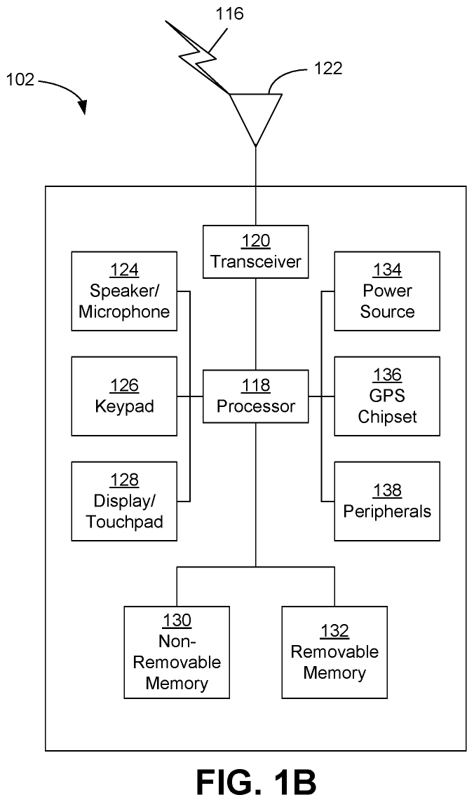

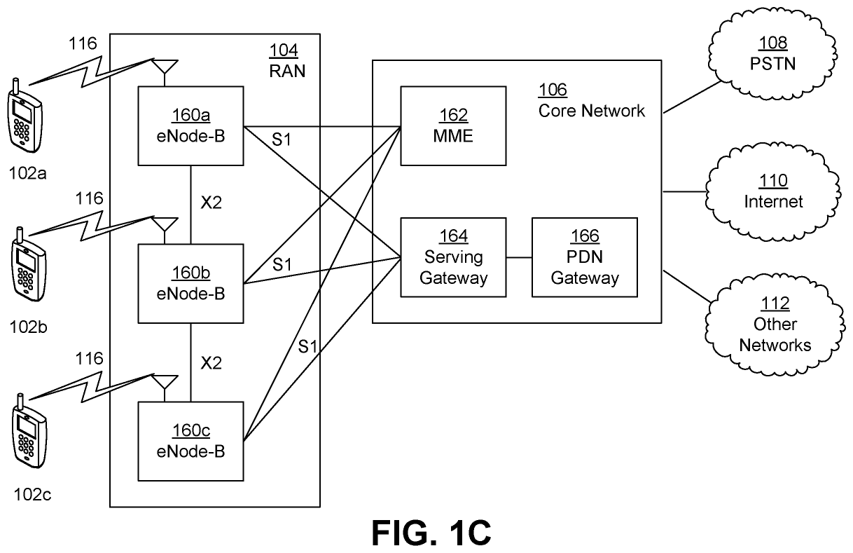

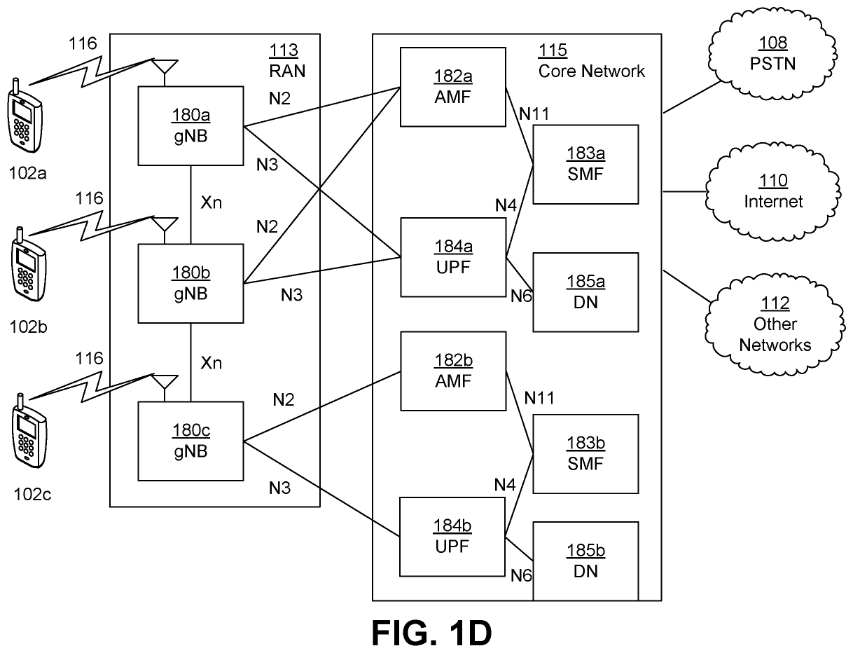

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like, As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 1020, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 1020, and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WIMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like.

The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may Include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links), For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram Illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NIMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology, Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface, The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802. 11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may Include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WIFI. The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may provide its session management (SM) and/or mobility management (MM) related capabilities to a network device (e.g., a core network device). For example, the WTRU may send its MM core network capability information to an access and mobility management function (AMF) during a registration procedure (e.g., an initial registration procedure) and/or a mobility registration update procedure, e.g., via a non-access stratum (NAS) message. The WTRU may indicate its SM related core network capability information via a PDU session establishment or modification request or message. The capability information may include the WTRU's access traffic steering, switching and splitting (ATSSS) capabilities and/or the WTRU's DualSteer capabilities.

A WTRU may register with a network if the WTRU wants to access services provided by the network that may require registration. The WTRU may carry out a series of operations associated with the registration. For example, the WTRU may select a mobile network (e.g., via a public land mobile network (PLMN) selection procedure or a standalone non-public network (SNPN) selection procedure). This network may be a public network or a non-public network. The WTRU may follow rules to determine how to select from the available networks at a given location, and/or when to look for a higher priority network. The WTRU may select a cell (e.g., a best cell) on a selected network via a cell selection procedure and the WTRU may camp on the selected cell. The WTRU may evaluate (e.g., continually) the cell quality and, if necessary, may switch to (e.g., camp on) a different cell, for example, via a cell reselection procedure. The WTRU may inform the network about the WTRU's presence and/or provide coarse location Information to the network, e.g., during the registration procedure.

A WTRU may support carrier aggregation (CA), which may be provided over a single cellular (e.g., third generation partnership project (3GPP) access leg (e.g., a new radio (NR) or long term evolution (LTE) access leg) and/or allow the WTRU to transmit and/or receive data over two or more cells. The cells may be associated with different frequency carriers. The use of the cells may be managed (e.g., entirely) by a radio access network (RAN).

A WTRU may support dual connectivity (DC), which may allow the WTRU to receive and/or transmit data over two cellular (e.g., 3GPP) access legs. The accesses may be based on NR (e.g., via a base station such as a gNB) and/or LTE (e.g., via a base station such as an eNB). In some examples (e.g., in 5G/NR), a deployment (e.g., initial deployment) may include a first access leg over a first RAT such as LTE and a second access leg over a second RAT such as NR. In some examples, the two access legs may be over the same RAT such as over NR and the two access legs may be on different bands (e.g., frequency range 1 (FR1) and frequency range 2 (FR2), respectively). The WTRU may use a radio frequency (RF) front end to support both access legs. One of the access legs may be a master leg (e.g., as part of a master cell group (MCG) while the other one may be a secondary leg (e.g., as part of a secondary cell group (SCG)).

The term “access leg” may be used interchangeably herein with the term “network access leg” or “communication network access leg.”

A WTRU may support communication over satellite links that may allow the WTRU to receive and/or transmit data over a transparent satellite and/or a repeater (e.g., the satellite and/or repeater may be in different orbits such as the geostationary earth orbit (GEO), the medium earth orbit (MEO), the low earth orbit (LEO), or the high-altitude platform station (HAPS). The WTRU may use an RF front end to communicate over the transparent satellite or the repeater.

A WTRU may support various combinations of dual connectivity and carrier aggregation. For example, the WTRU may use dual connectivity over two cellular (e.g., 3GPP) access legs and, in either or both of those access legs, the WTRU may use carrier aggregation. The set of cells on an access leg may be referred to as a cell group. The WTRU may support dual connectivity over one or multiple access legs over a transparent satellite or repeater link. For example, the WTRU may support one or more of the following scenarios. In a first scenario, a first access leg may be over NR and a second access leg may be over a GEO satellite. In a second scenario, a first access leg may be over NR and a second access leg may be over an LEO or MEO satellite. In a third scenario, a first access leg may be over a GEO satellite and a second access leg may be over an LEO or MEO satellite.

A WTRU operating under DC may be subject to certain limitations such as how a data radio bearer (DRB) may be mapped over two access legs. For example, an MCG bearer may be configured as a data bearer that may operate over a master leg, an SCG bearer may be configured as a data bearer that may operate over a secondary leg, and a split bearer may be configured as a data bearer that that may split its operations between a master leg and a secondary leg (e.g., processing tasks above the radio link control (RLC) layer may be performed in the master leg and processing tasks below the packet data convergence layer (PDCP) may be performed in the secondary leg). In one or more (e.g., each) of these configurations, the over-the-air transmissions of the data bearer may be performed over a single access leg.

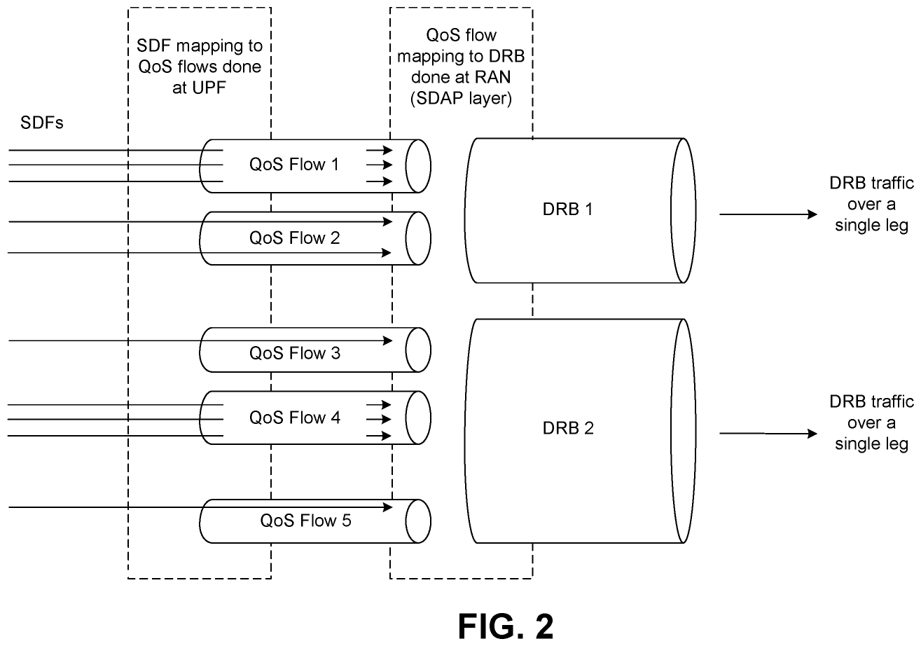

FIG. 2 illustrates how downlink (DL) service data flows (SDFs) may travel over a communication network (e.g., a 5G network) and/or over a data radio bearer. As shown, at an ingress point such as a user plane function (UPF), the SDFs may be mapped to QoS flows. The traffic associated with these QoS flows may be received by a RAN (e.g., a base station), where the traffic may be mapped to one or more DRBs and transmitted over a radio interface. In some examples, an SDF may be mapped to a QoS flow (e.g., a single QOS flow), a QOS flow may be mapped to a DRB (e.g., a single DRB), and a DRB may be transmitted over the air via an access leg (e.g., a single 3GPP radio access leg). In these examples, different SDFs may rely on DC and be transmitted over different cellular (e.g., 3GPP) access legs, but a single SDF flow may not be split, switched, steered, or duplicated over different access legs (e.g., over two 3GPP access legs). In other words, the traffic associated with an SDF may be carried over a single cellular (e.g., 3GPP) access leg, which may be changed via an RAN layer configuration or reconfiguration (e.g., the process may be slow compared to a dynamic configuration implemented via downlink control transmission (DCI).

Embodiments of the present disclosure contemplate that, different from the example shown in FIG. 2, data or traffic associated with an SDF may be split, switched, steered, and/or duplicated over multiple (e.g., two) network access legs (e.g., the splitting, switching, steering, or duplicating may be performed at an upper layer, pertaining to a same data session and/or with a single subscription to a PLMN). The splitting, switching, steering, or duplicating may be implemented in one or more of the following scenarios. A first scenario may involve a single PLMN, a PLMN plus a non-public network (NPN) such as a standalone non-public network (SNPN), or two PLMNs. A second scenario may involve networks of the same RAT or networks of different RATs. For example, in the second scenario, a first network may be an NR network or a non-terrestrial network (NTN), while the second network may be an NR network, an NTN (e.g., a non-cellular network), or an LTE network. In the PLMN plus PLMN or PLMN plus NPN scenario, the two networks may be managed by the same operator or by different operators, A steering mode may be configured for a service data flow. When used herein, the term “steering mode” may encompass ways for steering, splitting, switching and/or duplicating traffic or data over multiple access legs. A network device or function such as a policy control function (PCF) may provide a steering mode configuration to a WTRU (e.g., in the form of one or more ATSSS rules) and/or to a UPF (e.g., in the form of one or more N4 rules). The PCF may determine the configuration based on one or more QoS requirements (e.g., provided by an application function (AF) and/or the capability of the WTRU. The PCF may change the steering mode configuration for a service data flow, for example, based on a change in the QoS requirements.

ATSSS may allow a WTRU to split, steer, switch, and/or duplicate traffic associated with a service data flow (SDF) over a cellular (e.g., 3GPP) access leg and/or a non-cellular (e.g., non-3GPP) access leg. In comparison, DC may allow the WTRU to transmit or receive a first SDF and a second SDF over a first cellular access leg and a second cellular access, respectively, but DC may not allow the WTRU to split, steer, switch, or duplicate traffic associated with the first SDF or the second SDF across multiple (e.g., two) cellular access legs (e.g., with DC, the splitting, steering, switching, or duplication of traffic may be done at the data radio bearer level and not at the SDF level). The access legs supported by DC may be terrestrial or non-terrestrial, and the access legs may be implemented over one or more PLMNs or one or more SNPNs.

As described herein, it may be desirable to allow ATSSS functionalities such as splitting, steering, switching, and/or duplicating the traffic associated with an SDF (e.g., for a PDU session) over multiple (e.g., two) access legs (e.g., including non-terrestrial 3GPP access legs and/or SNPN access legs). Such ATSSS functionalities may include DualSteer functionalities, which may allow a WTRU to split, steer, switch, and/or duplicate traffic associated with a service data flow (SDF) over a first cellular (e.g., 3GPP) access leg and/or a second cellular (e.g., 3GPP) access leg (e.g., DualSteer may be based on ATSSS). The multiple access legs used by ATSSS or DualSteer may be associated with a same RAT (e.g., two cellular access legs such as two NR access leg), with different RATs (e.g., an LTE access leg and an NR access leg), with different RAT types (e.g., a terrestrial access and a satellite access), with different PLMNs, or with different PLMN types (e.g., HPLMN, NPN, and VPLMN). For example, with ATSSS, a first access leg may be a cellular (e.g., 3GPP) access leg, a second access leg may be a non-cellular (e.g., non-3GPP) access leg, and a decision to switch, steer, split, and/or duplicate traffic may be made at an SDF level (e.g., the network may have control of when this occurs through the steering mode rules described herein). With DualSteer, a first access leg may be a cellular (e.g., 3GPP) access leg, a second access leg may also be a cellular (e.g., 3GPP) access leg, and a decision to switch, steer, split, and/or duplicate traffic may also be made at an SDF level (e.g., the network may have control of when this occurs through the steering mode rules described herein). With DC, a first access leg may be a cellular (e.g., 3GPP) access leg, a second access leg may also be a cellular (e.g., 3GPP) access leg, and a decision to switch, steer, split, and/or duplicate traffic may be made at a data radio bearer (DRB) level (e.g., the network may have little control of when this occurs). Restrictions may be imposed on how traffic may be split, steered, switched, and/or duplicated over the multiple access legs. These restrictions may allow a WTRU and/or a network device (e.g., a UPF) to dynamically and/or autonomously change the manner of splitting, steering, switching, and/or duplicating traffic over the multiple access legs.

In some implementations of ATSSS, a configuration associated with splitting, steering, switching, and/or duplicating traffic may be static (e.g., the configuration may be done via an RRC message). In these implementations, while a network device may implement an ATSSS restriction by modifying a configuration or changing ATSSS from a first type (e.g., splitting traffic over two access legs) to a second type (e.g., duplicating the traffic over two access legs), the process may be slow (e.g., compared to allowing a WTRU to decide locally when to apply an ATSSS restriction) due to session management related signaling that may be involved. In some implementations of ATSSS, a network may not be allowed to configure ATSSS restrictions (e.g., how traffic may be split, steered, switched, or duplicated, and under what conditions). For example, in these implementations of ATSSS, the network may not be allowed to configure a WTRU to only use a redundant steering mode when the WTRU's battery power is above a certain level (e.g., when the WTRU's battery power is deemed sufficient).

Multiple steering modes may be defined in the context of ATSSS or DualSteer. These steering models may include but may not be limited to an Active-Standby mode, a Load Balancing mode, a Priority mode, a Smallest Delay mode, and/or a Redundant Steering Mode. When used herein, a steering mode rule or restriction may indicate a steering mode to be used, a configuration for a steering mode, a validity condition or restriction for a steering mode, a measurement configuration associated with a steering mode, the priority of the steering mode rule, whether the steering mode rule is an initial rule, whether a steering mode rule is a default rule, etc. The steering mode rule or restriction may allow a WTRU and/or a network device (e.g., a UPF) to switch (e.g., dynamically) from one steering mode to another steering mode if certain conditions are satisfied.

When used herein, a steering mode policy may indicate a list of steering mode rules, steering mode capabilities may indicate support for one or more steering modes or steering mode restrictions, and a transmission mode may indicate how traffic may be transmitted. A transmission mode may be defined for the uplink or the downlink. For example, a transmission mode for the uplink may be associated with one or more of a GEO, an MEO, an LEO, an uncrewed aerial vehicle (UAV), a Relay WTRU, a frequency band, a licensed band, an unlicensed band, NR, and/or LTE. For the downlink, a transmission mode may be associated with one or more of a GEO, an MEO, an LEO, a UAV, a Relay WTRU, a frequency band, a licensed band, an unlicensed band, NR, LTE, multicast, broadcast, and/or unicast.

It should be noted here that the examples described herein may be applicable to DualSteer, which may use two cellular (e.g., 3GPP) access legs, and to ATSSS, which may use two cellular access legs or one cellular access leg and one non-cellular (e.g., non-3GPP) access leg.

One or more steering mode policies may be defined to enable the application of steering mode restrictions. The steering mode restrictions may be included in a steering mode policy, which may be defined by a network entity such as a PCF. A WTRU and/or a network function such as a UPF may implement procedures to facilitate the application of these steering mode restrictions. For example, the WTRU and/or UPF may change (e.g., dynamically) a steering mode as the conditions at the WTRU and/or UPF change. As another example, after the WTRU establishes a multi-access PDU (MA-PDU) session with DualSteer functionalities, the WTRU may have preferences for how to use two cellular access legs based on the WTRU's power status, roaming status, orientation, etc., and the techniques described herein may allow the WTRU to realize those preferences by dynamically determining how the two access legs are used.

A steering mode policy (SMP) may be provided to a WTRU and/or a network function such as a UPF. The SMP may include a list of steering mode rules. A steering mode rule may include one or more of a traffic descriptor, a steering mode descriptor, a steering mode priority, a configuration for the steering mode, or a validity restriction (e.g., also referred to herein as a validity condition) for the steering mode. The SMP may be provided to the WTRU in one or more of the following manners. The SMP may be provided via a PDU session establishment procedure. The SMP may be provided via a PDU session modification procedure. The SMP may be provided via a WTRU configuration update procedure. The SMP may be provided via a registration procedure (e.g., in a registration accept message).

A steering mode policy may allow a network device or entity (e.g., a PCF) to configure one or multiple steering modes for a WTRU or another network device (e.g., UPF). A steering mode policy may allow a WTRU (or a UPF) to determine (e.g., dynamically) which steering mode (e.g., among multiple configured steering modes) to use based on specific conditions.

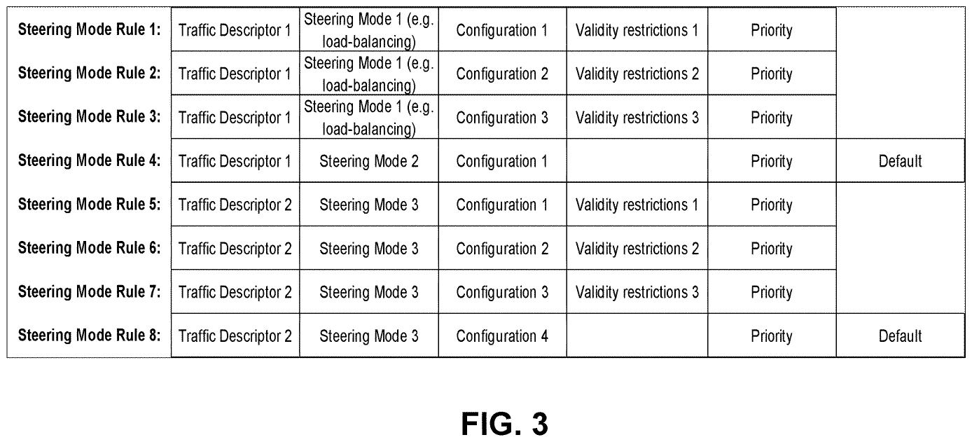

FIG. 3 illustrates an example of a steering mode policy. As shown in FIG. 3, the steering mode policy may include one or more steering mode rules, and multiple (e.g., all) steering mode rules associated with the same traffic descriptor may apply to the same service data flow (e.g., Steering Mode Rules 1-4, which are associated with Traffic Descriptor 1, may belong to the same service data flow, as shown in FIG. 3). Also as shown in FIG. 3, a steering mode rule may be set as a default steering mode rule (e.g., to be used when no other steering mode rule is provided or valid). The steering mode policy may indicate which steering mode rule is the default steering mode rule. In examples, the default steering mode rule may have the lowest priority and/or may have no validity restrictions (e.g., the default steering mode rule may always be valid). An indication that a steering mode rule is the default steering mode rule may be provided implicitly, for example, based on the absence of validity restrictions for that steering mode rule or the fact that the steering mode rule is associated with the lowest steering mode priority. A steering mode rule may be set as an initial steering mode rule to be used (e.g., when DualSteer Is first enabled at a WTRU or a UPF). Such an initial steering mode rule may be indicated in the steering mode policy.

One or more of the following validity restrictions (also referred to herein as validity conditions) may be provided or configured for a steering mode rule. The validity restrictions may indicate the conditions under which the steering mode rule may be valid or applicable. As an example, a validity restriction may be based on a time or schedule associated with a WTRU. For instance, a steering mode rule may specify a time period during which the rule may be considered valid for the WTRU (e.g., outside this time period, the rule may be considered invalid). As another example, a validity restriction may be based on a location associated with a WTRU. For instance, a steering mode rule may specify a geofence location, a cell ID, a list of cell IDs, a tracking area ID, a list of tracking area IDs, a country, a proximity to a cell, a proximity to a UAV, a proximity to another WTRU, and/or the like, with which the rule may be considered valid for the WTRU. As yet another example, a validity restriction may be based on the power of a WTRU. For instance, a steering mode rule may indicate whether the rule is valid while the WTRU is operating on battery power or while the WTRU is operating on main power. The steering mode rule may indicate a battery level (or status) at which the rule may be deemed valid for the WTRU. The battery level or status may be defined as a relative term such as “poor,” “average,” or “good.” The battery level or status may be defined as a percentage such as “less than 35%,” “between 35% and 70%,” “greater than 70%,” etc. As yet another example, a validity restriction may be based on the orientation of a WTRU. For instance, a steering mode rule may indicate whether the rule is valid while a WTRU is in a portrait mode or while the WTRU is in a landscape mode.

A validity restriction may be based on a transmission mode such as a UL transmission mode of a WTRU. Such a transmission mode may determine how the WTRU may transmit information (e.g., UL traffic) over an access leg. For example, a steering mode rule may indicate whether the rule is valid while a transmission (e.g., communication over an access leg) is performed via specific equipment or a specific medium such as, e.g., via terrestrial equipment (e.g., via a gNB or an eNB), via a geosynchronous satellite, via an MEO satellite, via an LEO satellite, via a UAV, or via a ProSe WTRU. As another example, a steering mode rule may indicate whether the rule is valid while a transmission is performed over a specific RAT type such as, e.g., NR, LTE, a non-3GPP RAT, and/or the like. As yet another example, a steering mode rule may indicate whether the rule is valid while a transmission is performed over a specific type of frequency bands such as, e.g., an unlicensed band, a licensed band, etc. As yet another example, a steering mode rule may indicate whether the rule is valid while a transmission is performed over one frequency band or multiple frequency bands.

A validity restriction may be based on a transmission mode such as a DL transmission mode. Such a DL transmission mode may determine how a WTRU may receive information (e.g., downlink traffic) over an access leg. For example, a steering mode rule may indicate whether the rule is valid while a downlink transmission (e.g., a DL transmission over an access leg) is performed via specific equipment or a specific medium such as, e.g., terrestrial equipment (e.g., a gNB or an eNB), a geosynchronous satellite, an MEO satellite, an LEO satellite, a UAV, a Relay WTRU, etc. As another example, a steering mode rule may indicate whether the rule is valid while a downlink transmission is performed over a specific RAT type such as, e.g., NR, LTE, a non-3GPP RAT, etc. As yet another example, a steering mode rule may indicate whether the rule is valid while a downlink transmission is performed over a specific type of frequency bands such as, e.g., an unlicensed band, a licensed band, etc. As yet another example, a steering mode rule may indicate whether the rule is valid while a downlink transmission is performed over one frequency band or over multiple frequency bands. As yet another example, a steering mode rule may indicate whether the rule is valid while a downlink transmission is performed using multicast, broadcast, or unicast.

A validity restriction may be based on a cost associated with implementing a steering mode or a steering mode rule. A validity restriction may be based on the performance of a transmission link such as UL performance or DL performance over an access leg. For example, a steering mode rule may indicate a minimum performance requirement (e.g., UL or DL performance over an access leg) with which the rule may be valid. If such a performance requirement is not met, the rule may be considered invalid. For instance, the steering mode rule may indicate that the rule may be applied when UL or DL quality is poor.

A validity restriction may be based on a quality of experience (QoE). A QoE measurement may be provided by an application installed and running on a WTRU, as reported by an application server, a network function, etc. Based on the QoE measurement, the WTRU may select one steering mode rule over another steering mode rule.

Although the validity restrictions may have been described herein individually, they may also be combined. In a first example combination, a steering mode rule may be restricted to being applicable only at a certain location and certain times of the day. In such a combination, the steering mode rule may have a time-based restriction and a location-based restriction. For instance, the steering mode rule may indicate that the rule may be used between “8 AM and 9 AM” and “within 500 m of geolocation (X, Y).” In a second example combination, a steering mode rule may be restricted to being applicable only if a WTRU is connected over a Relay WTRU and/or is slow moving. In such a combination, the steering mode rule may have an UL transmission mode restriction and a speed restriction. For Instance, the steering mode rule may indicate that the rule may be used when the UL transmission mode is “Relay WTRU” and WTRU's speed (e.g., traveling speed) is “<50 kph.”

A steering mode policy may include multiple steering mode rules associated with the same steering mode. For example, as shown in FIG. 3, Steering Mode Rules 1, 2, and 3 may all be associated with Steering Mode 1 (e.g., load balancing), with different configurations. Examples of these different configurations for a (e.g., each) steering mode may include one or more of the following. For example, if the steering mode is set to Load-Balancing, the different configurations may have different splits of percentage across multiple access legs, different steering mode indicators, different measurement configurations for determining a round trip time (RTT) or a packet loss rate (PLR), and/or different threshold values. If the steering mode is set to Active-Standby, the different configurations may have different active legs and/or standby legs. If the steering mode is set to Smallest Delay, the different configurations may have different measurement configurations for determining an RTT. If the steering mode is set to Priority-based, the different configurations may have different priorities for different access legs, different measurement configurations for determining an RTT, different measurement configurations for determining an PLR, and/or different threshold values. If the steering mode is set to Redundant Steering Mode, the different configurations may have different primary accesses, different measurement configurations for determining an RTT or a PLR, or different threshold values.

The measurement configurations described herein may indicate what metrics to measure (e.g., a PLR and/or RTT) and/or when to measure the metrics. For example, the measurement may be periodic based on a configured period (e.g., a measurement configuration may indicate that the measurement is to be performed every T msecs). As another example, the measurement may be aperiodic based on monitored events. For instance, a measurement configuration may indicate that the measurement is to be performed after a cell change on an access leg, or after an inter-RAT cell change on an access leg. A measurement configuration may indicate what information to transmit to a peer entity (e.g., for measurement of a PLR or RTT) and at what frequency to send the information.

A (e.g., each) steering mode rule may be augmented by adding a list of preferred access types, which may be used to determine the access network(s) to look for and/or connect to. For example, a steering mode rule may indicate to a WTRU that the preferred access type is GEO.

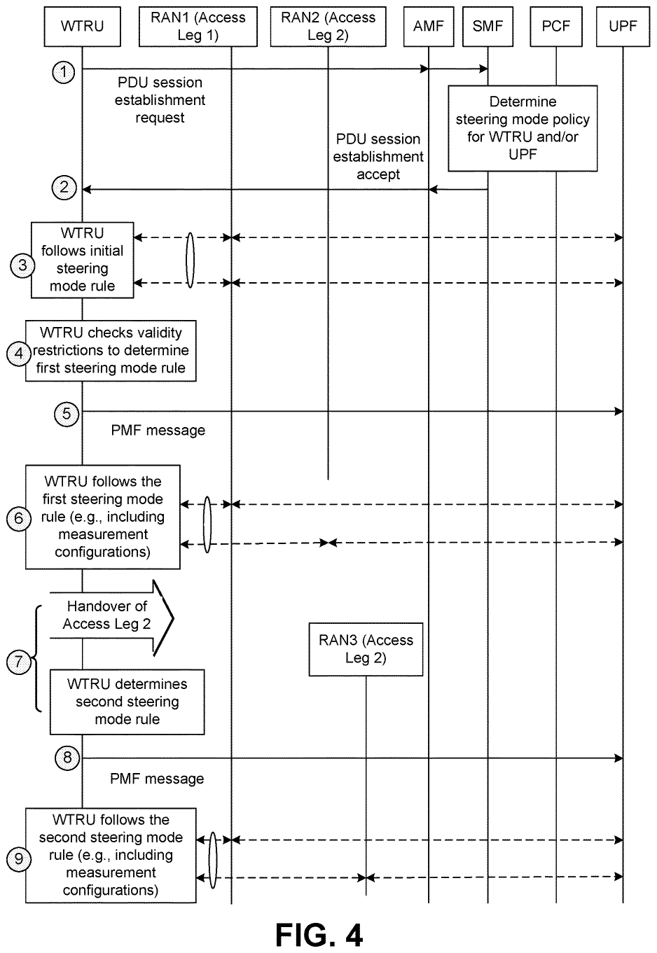

A WTRU may take actions to enable or apply a steering mode (e.g., including splitting, switching, steering, and/or duplicating) rules or restrictions. FIG. 4 illustrates example actions that may be performed by a WTRU to support steering mode rules and/or change a steering mode dynamically and autonomously. At 1 of FIG. 4, the WTRU may send a PDU session establishment message (e.g., a PDU session establishment request) to a network (e.g., to an AMF or SMF) to request establishment of a multiple-access PDU (MA-PDU) session. The message may include an indication that the WTRU supports steering mode rules and restrictions. The message may include an indication of a preference of the WTRU with respect to one or more access legs. As an example, such a preference may be related to minimizing the use of one transmission mode over another transmission mode. For instance, the WTRU may indicate a preferred granularity (e.g., an expected granularity) and a preference to minimize the use of NR over LTE. The preferred granularity may indicate a number of steering mode rules expected by the WTRU. For example, the preferred granularity may indicate a preference to have at least three steering mode rules related to the transmission mode preference to minimize the use of NR over LTE. As another example, the preference may be related to maximizing the use of one transmission mode over another transmission mode. For instance, the WTRU may indicate a preferred granularity (e.g., an expected granularity) and a preference to maximize the use of operating band 1 over operating band 2. The preferred granularity may indicate a number of steering mode rules expected by the WTRU. For example, the preferred granularity may indicate a preference to have at least three steering mode rules related to the transmission mode preference to maximize the use of operating band 1 over operating band 2.

As yet another example, the preference may be related to minimizing the use of roaming. For instance, the WTRU may request to have a limit on an access leg based on whether the access leg is in a VPLMN (e.g., the WTRU may prefer to limit the traffic associated with an access leg of a VPLMN to 25%). As yet another example, the preference may be related to a time. For instance, the WTRU may prefer to use certain accesses at certain times of the day and the WTRU may provide an indication of the specific times and accesses preferred. As yet another example, the preference may be related to the WTRU's orientation. For instance, the WTRU may request to have a limit on an access leg based on the WTRU's orientation (e.g., the WTRU may prefer to limit the traffic on an NR leg to 10% if the WTRU's orientation is portrait). As yet another example, the preference may be related to the WTRU's power. For instance, the WTRU may request to have a limit on an access leg based on the WTRU's power level or conditions. The WTRU may provide an indication of the maximum traffic on an access leg and/or the corresponding power condition. For example, the WTRU may indicate to the network to limit the traffic on a GEO leg to 10% if the WTRU is battery powered, or to split traffic evenly on two access legs if WTRU is mains powered.

As another example, the preference may be related to the WTRU's speed (e.g., traveling speed). For instance, the WTRU may request to have a limit on an access leg based on the WTRU's speed (e.g., the WTRU may prefer to limit traffic on an access leg over a Relay WTRU to 10% if the WTRU's speed is greater than 50 mph). As yet another example, the preference may be related to a UL quality. For example, the WTRU may request to have more measurement reporting if the WTRU determines that the UL performance is below some threshold. As yet another example, the preference may be related to a DL quality. For example, the WTRU may request to have more measurement reporting if the WTRU determines that the DL performance is below some threshold.

At 2 of FIG. 4, if the network accepts the WTRU's request to establish an MA-PDU session with steering mode restrictions, the network (e.g., an SMF or PCF) may determine a steering mode policy for the WTRU (and/or for another network device such as a UPF), and the WTRU may receive the steering mode policy from the network (e.g., the PCF), for example, via a PDU session establishment response. As described herein, the steering mode policy may include a list of steering mode rules and validity restrictions (e.g., validity conditions) for the steering mode rules.

At 3 of FIG. 4, the WTRU may apply an initial steering mode rule to split, switch, steer, and/or duplicate traffic across multiple (e.g., two) access legs. The WTRU may follow a measurement configuration for the initial steering mode rule (e.g., the WTRU may apply the measurement configuration as part of the initial steering mode rule).

At 4 of FIG. 4, the WTRU may check one or more validity restrictions or conditions for the steering mode rules configured for the WTRU. Such validity restrictions or conditions may allow the WTRU to dynamically change a steering mode or switch to a different steering mode based on conditions (e.g., local conditions) at the WTRU. The WTRU may go over the configured steering mode rules (e.g., starting with the steering mode rule having the highest priority) and select a steering mode rule (e.g., a different steering mode rule than the initial steering mode rule) that may be considered valid (e.g., a steering mode rule may be considered valid if the validity restriction(s) or condition(s) associated with the steering mode rule is satisfied).

The WTRU may check the validity restriction(s) for one or more steering mode rules (e.g., for each steering mode rule). For example, if a validity restriction is based on time, the WTRU may determine the current time and select the steering mode rule if the time is considered valid according to the validity restriction. For instance, if the validity restriction for applying a steering mode rule is between 8 AM and 9 AM, the WTRU may check to determine whether the current time is between 8 AM and 9 AM. As another example, if the validity restriction for a steering mode rule is based on location, the WTRU may determine its current location and apply the steering mode rule if the location considered valid according to the validity restriction. The WTRU may determine the location based on the format of the validity restriction, For example, the validity restriction may specify a valid location as a geolocation, a cell ID, a list of cell IDs, a tracking area, a list of tracking areas, the ID of a nearby WTRU, a list of IDs for nearby WTRUs, etc. As such, if the validity restriction refers to a geofence, the WTRU may check to determine if its current geolocation is within the geofence. Similarly, if the validity restriction refers to a cell ID, the WTRU may check to determine if its current cell corresponds to this cell ID.

As yet another example, if a validity restriction for a steering mode rule is based on speed, the WTRU may determine its current speed (e.g., traveling speed) and select the steering mode rule if the speed is valid according to the validity restriction. The speed may be determined by an application in the WTRU, or it may be determined based on the number of cell selections within a period of time. As yet another example, if a validity restriction for a steering mode rule is based on power, the WTRU may determine its power state and select the steering mode rule if the power state is valid according to the validity restriction. For example, the WTRU may have 2 steering mode rules, a first one with a validity restriction set to “battery powered” and a second one with a validity restriction set to “mains powered,” and the WTRU may determine whether apply the first steering mode rule or the second steering mode rule based on whether the WTRU is “battery powered” or “mains powered.” The validity restriction for a steering mode rule may also be based on a battery status such as “good,” “average,” or “poor.”

If the validity restriction for a steering mode rule is based on an orientation of the WTRU, the WTRU may determine its orientation and select the steering mode rule if the orientation is valid according to the validity restriction. If the validity restriction for a steering mode rule is based on a UL transmission mode, the WTRU may determine the UL transmission mode and select the steering mode rule If the UL transmission mode is valid according to the validity restriction. For example, the WTRU may determine the UL transmission mode based on information carried in serving cell system information, which may include an indication of whether the cell is a terrestrial cell, a GEO cell, an LEO cell, or an MEO cell. The system information may also include an indication of a RAT type (e.g., NR vs LTE) or an indication of a PLMN of the serving cell. The WTRU may also determine the UL transmission mode based on dedicated RRC signaling with a serving cell, NAS signaling with a core network, discovery signaling exchanges with a UAV or a Relay WTRU, and/or a pre-configured mapping between UL frequencies and UL transmission modes. For example, the WTRU may be pre-configured with a mapping between UL frequencies and RAT types, or a mapping between UL frequencies and operating bands, or a mapping between UL frequencies and whether the frequencies are in a licensed or unlicensed band.

If the validity restriction for a steering mode is based on a DL transmission mode, the WTRU may determine the DL transmission mode and select the steering mode rule if the DL transmission mode is valid according to the validity restriction. The WTRU may determine the DL transmission mode based on information carried in serving cell system information. For example, the system information may include an indication of whether the cell is a terrestrial cell, a GEO cell, an LEO cell, or an MEO cell. The system information may also include an indication of a RAT type (e.g., NR vs LTE) or an indication of a PLMN of the serving cell. The WTRU may also determine the DL transmission mode based on dedicated RRC signaling with a serving cell, NAS signaling with a core network, discovery signaling exchange with a UAV or a Relay WTRU, and/or a pre-configured mapping between DL frequencies and DL transmission modes. For example, the WTRU may be pre-configured with a mapping between DL frequencies and operating bands, or a mapping between DL frequencies and whether the frequencies are in a licensed or unlicensed band. As yet another example, the WTRU may determine, based on system information or dedicated signaling, whether a service data flow is offered through unicast transmissions, broadcast transmissions, or multicast transmissions.

If a validity restriction for a steering mode rule is based on the UL quality over an access leg, the WTRU may determine the performance/quality of the UL over the access leg before applying the steering mode rule, The UL performance may be based on UL statistics, such as HARQ feedback. Based on these statistics, the WTRU may use one or more thresholds to determine if the UL quality is acceptable or poor. If the UL quality on the access leg is valid according to the validity restriction, the WTRU may select the steering mode rule.

If a validity restriction for a steering mode rule is based on the DL quality over an access leg, WTRU may determine the performance/quality of the DL over the access leg. The DL performance may be based on DL measurements such as the RSRP, RSRQ, and RSSI of a signal, channel, beam, carrier, link, etc. associated with the DL. Based on these measurements, the WTRU may use one or more thresholds to determine if the DL quality is acceptable or poor. If the DL quality on the access leg is valid according to the validity restriction, the WTRU may select the steering mode rule.

At 5 of FIG. 4, if the WTRU dynamically changes a steering mode or switches to a different steering mode rule, the WTRU may notify the network (e.g., the UPF) about the change or switching. This may be accomplished via a performance management function (PMF) message that may include one or more of the following: the steering mode rule in use or to be used by the WTRU, the WTRU's location, the WTRU's power status, the WTRU's orientation, the WTRU's speed, the WTRU's trajectory, the WTRU's UL transmission mode, the WTRU's DL transmission mode, etc.

At 6 of FIG. 4, the WTRU may apply the steering mode rule that matches the validity restriction or condition to split, switch, steer, and/or duplicate traffic across multiple (e.g., two) access legs. If necessary, the WTRU may follow a measurement configuration associated with the newly selected steering mode rule.

At 7 of FIG. 4, a validity restriction or condition may change, for example, due to a handover performed the WTRU over access leg 2 from a licensed band to an unlicensed band. As a result of the handover, a steering mode rule with a higher priority may become valid and the WTRU may, in response, dynamically change its steering mode to match the valid steering mode rule.

At 8 of FIG. 4, the WTRU may notify the network (e.g., such as the UPF) about the change, for example, via a PMF message.

At 9 of FIG. 4, the WTRU may operate in accordance with the steering mode rule selected at 7.

At 2 of FIG. 4 described herein, the network may decide to reject the PDU session establishment request from the WTRU. In such a case, the network may configure a single steering mode for the WTRU, and the WTRU may accept an MA-PDU session established based on the single steering mode, or the WTRU may reject the MA-PDU session established based on the single steering mode and request a single-access PDU (SA-PDU) session over a single access leg. In addition, the operations associated with 5 of FIG. 4 may occur at the same time as the operations associated with 6 of FIG. 4 or subsequent to (e.g., immediately following) the operations at 6 of FIG. 4. Further, the operations associated with 8 of FIG. 4 may occur at the same time as the operations associated with 9 of FIG. 4 or subsequent to (e.g., immediately following) the operations associated with 9 of FIG. 4.

A WTRU may be configured with ATSSS (e.g., including DualSteer) capabilities and may carry out one or more of the following operations associated with steering mode restrictions. The WTRU may send a PDU session establishment request message to the network, which may indicate the WTRU's capabilities to support the steering mode restrictions and/or the WTRU's preferences related to the use of different access legs. The WTRU may receive a PDU session establishment response (e.g., acceptance) from the network, which may include a steering mode policy (e.g., indicating a list of steering mode rules). Based on the steering mode policy, the WTRU may determine an initial steering mode rule (e.g., based on validity restrictions associated with the rule and conditions at the WTRU), and may follow the initial steering mode rule to split, switch, steer, and/or duplicate uplink traffic across multiple access legs (e.g., across two access legs under DualSteer) according to the rule. The WTRU may follow a measurement configuration associated with the initial steering mode rule. Subsequently, the WTRU may, based on the validity restrictions indicated in the steering mode policy and/or conditions associated with the WTRU, determine that another steering mode rule (e.g., a higher priority steering mode rule) has become valid (e.g., applicable). In response, the WTRU may follow the other (e.g., higher priority) steering mode rule to split, switch, steer, and/or duplicate uplink traffic across the access legs. The WTRU may also follow a measurement configuration associated with the other steering mode rule. Additionally, the WTRU may send a PMF message to the network (e.g., a UPF) and may indicate the other steering mode rule adopted by the WTRU and/or its associated validity restrictions in the PMF message.

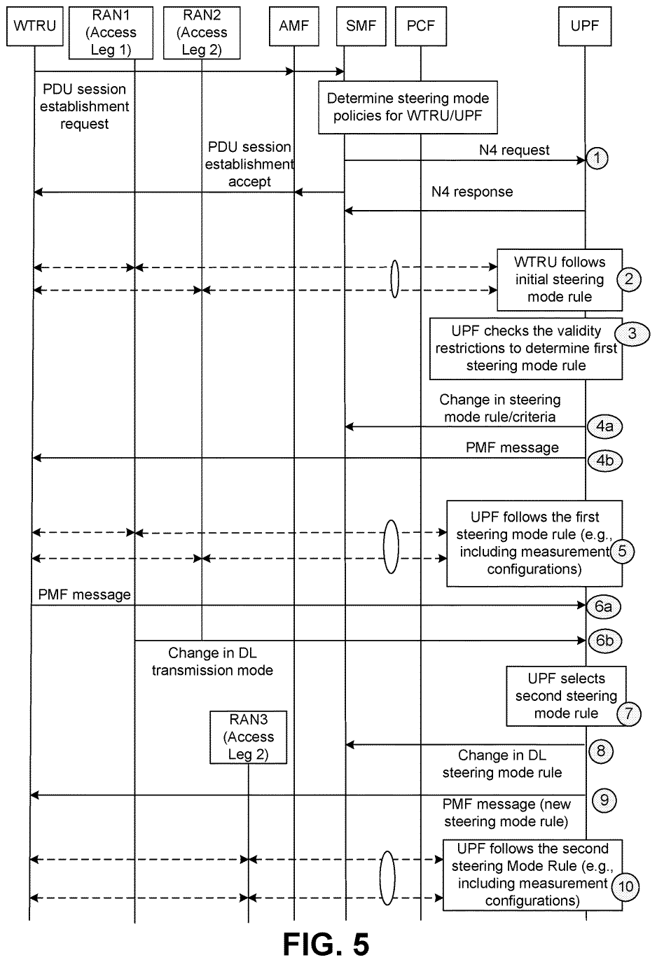

A network device or function such as a UPF may take actions to enable steering mode (e.g., including splitting, switching, steering, and/or duplicating) rules or restrictions. FIG. 5 illustrates example operations by a network device (e.g., such as a UPF) that may be associated with steering mode restrictions.

At 1 of FIG. 5, a network may accept a request from a WTRU to establish a MA-PDU session with one or more steering modes (e.g., dynamic steering modes) enabled and a UPF of the network may receive a steering mode policy from another network device or function such as a PCF. The steering mode policy may include a list of steering mode rules, which may also be indicated to the WTRU (e.g., via a PDU session establishment response indicating acceptance of the PDU session request).

At 2 of FIG. 5, the UPF may apply an initial steering mode rule to split, switch, steer, and/or duplicate traffic (e.g., downlink traffic) across multiple (e.g., two) access legs to the WTRU, and the WTRU may carry out corresponding actions (e.g., following certain measurement configurations) according to the initial steering mode rule, At 3 of FIG. 5, the UPF may check one or more validity restrictions associated with the steering mode rules, which may allow the UPF to dynamically change a steering mode (e.g., a DL steering mode) or switch to a different steering mode (e.g., a different DL steering mode) based on conditions (e.g., remote conditions) at the WTRU or conditions (e.g., local conditions) at the UPF, The UPF may go over the steering mode rules (e.g., starting with a steering mode rule with the highest priority) and select a valid steering mode rule (e.g., a first steering mode rule) based on the validity restrictions (e.g., a steering mode rule may be considered valid if one or more validity restrictions for the steering mode are satisfied). For example, the UPF may check the validity restrictions associated with one or more configured steering mode rules (e.g., with each configured steering mode rule) and decide which steering mode rule is applicable based on the restrictions and/or the aforementioned conditions. If the validity restriction associated with a steering mode rule is based on time, the UPF may determine the current time and select the steering mode rule if the time is deemed valid according to the steering mode restriction. For instance, if the validity restriction is between 8 AM and 9 AM, the UPF may check to determine if the current time is between 8 AM and 9 AM before selecting the corresponding steering mode rule. If the validity restriction associated with a steering mode rule is based on location, the UPF may determine location information associated with the WTRU and select the steering mode rule if the location information meets the steering mode restriction. The location information may include a geolocation, a cell ID, a list of cell IDs, a tracking area, a list of tracking areas, an ID of a nearby WTRU, a list of IDs for nearby WTRUs, etc. The UPF may determine the location information associated with WTRU from a location management function (LMF), based on the WTRU's context for an N3 or N9 interface (e.g., a cell ID), based on an indication received from the WTRU (e.g., via a PMF message), etc. For instance, if the validity restriction is associated with a geofence, the UPF may determine whether the WTRU's current geolocation is within the geofence. As yet another example, if the validity restriction is associated with a cell ID, the UPF may determine if the WTRU's current serving cell corresponds to this cell ID,

If the validity restriction associated with a steering mode rule is based on speed, the UPF may determine the WTRU's current speed (e.g., traveling speed) and select the steering mode rule if the speed is deemed valid according to the steering mode restriction. The UPF may determine the WTRU's speed based on an indication received from the WTRU (e.g., over a PMF message) or from an LMF. If the validity restriction associated with a steering mode rule is based on power, the UPF may determine the WTRU's power level or power state, and select the steering mode rule if the power level or state is deemed valid according to the steering mode restriction. The UPF may determine the WTRU's power level or state based on an indication received from the WTRU (e.g., via a PMF message). If the validity restriction associated with a steering mode rule is based on orientation, the UPF may determine the WTRU's orientation and select the steering mode rule if the orientation is deemed valid according to the steering mode restriction. The UPF may determine the WTRU's orientation based on an indication received from the WTRU (e.g., via a PMF message).

If the validity restriction associated with a steering mode rule is based on a UL transmission mode, the UPF may determine the UL transmission mode and select the steering mode rule if the UL transmission mode is deemed valid according to the steering mode restriction. For example, the UPF may determine the UL transmission mode based on information provided by a serving cell. Such information may indicate whether the serving cell is a terrestrial cell, a GEO cell, an LEO cell, or an MEO cell. The information may also indicate a RAT type associated with the serving cell (e.g., NR or LTE), a frequency of the serving cell, a frequency band of the serving cell, whether the serving cell is licensed or unlicensed, whether the WTRU is connected via a UAV or a Relay WTRU, etc.

If the validity restriction associated with a steering mode rule is based on a DL transmission mode, the UPF may determine the DL transmission mode and select the steering mode rule if the DL transmission mode is deemed valid according to the steering mode rule. For example, the UPF may determine the DL transmission mode based on information provided by a serving cell. Such information may indicate if the serving cell is a terrestrial cell, a GEO cell, an LEO cell, or an MEO cell. The information may also indicate a RAT type associated with the serving cell (e.g., NR or LTE), a frequency of the serving cell, a frequency band of the serving cell, whether the serving cell is licensed or unlicensed, whether the WTRU is connected via a UAV or a Relay WTRU, etc. The information may also indicate if a service data flow is provided over unicast transmissions, multicast transmissions, or broadcast transmissions.

If the validity restriction associated with a steering mode rule is based on a UL quality over an access leg, the UPF may determine the performance of the UL over an access leg based on an indication received from the WTRU (e.g., via a PMF message) or an indication received from an access node. If the validity restriction associated with a steering mode rule is based on a DL quality over an access leg, the UPF may determine the performance of the DL over the access leg based on an indication received from the WTRU (e.g., via a PMF message) or an indication received from an access node.

At 4a of FIG. 5, the UPF may inform another network device or function (e.g., an SMF or AMF) about the change in the steering mode rule and/or the set of changed criteria associated with the steering mode rule.

At 4b of FIG. 5, the UPF may inform the WTRU about the change in the steering mode rule (e.g., from the initial steering mode rule to the first steering mode rule). This may be accomplished via a PMF message that may include information regarding the steering mode rule to be applied by the UPF.

At 5 of FIG. 5, the UPF may apply the first steering mode rule to split, switch, steer, and/or duplicate traffic (e.g., downlink traffic) across multiple (e.g., two) access legs. As part of applying the first steering mode rule, the UPF may follow a measurement configuration for the first steering mode rule.

At 6a of FIG. 5, the WTRU may (e.g., dynamically) changes a steering mode (e.g., a UL steering mode) and may send an indication of the change to the UPF. This indication may be sent through a PMF message, which may indicate a steering mode rule (e.g., UL steering mode rule) used by the WTRU or a set of changed criteria (e.g., validity restrictions) applied by the WTRU.

At 6b of FIG. 5, an access node (e.g., a RAN node such as a base station) may also send an indication to the UPF that a DL transmission mode (e.g., from the RAN to the WTRU) has changed. For example, the RAN node may indicate to the UPF that a service data flow that was provided over unicast transmissions is now provided over multicast transmissions.

At 7 of FIG. 5, the UPF may, based on the indication received at 6a and/or 6b, select/apply a matching steering mode rule (e.g., a second steering mode rule) to split, switch, steer, and/or duplicate traffic (e.g., downlink traffic) across multiple (e.g., two) access legs, and the UPF may, at 8 of FIG. 5, inform another network function (e.g., the SMF or AMF) about the change in the steering mode rule.

At 9 of FIG. 5, the UPF may inform the WTRU about the change in the steering mode rule. This may be accomplished via a PMF message that may include information regarding the steering mode rule applied or to be applied by the UPF. At 10 of FIG. 5, the UPF may apply the steering mode rule and operate accordingly.

The operations associated with 6a of FIG. 5 as described herein may occur at the same time as the operations associated with 5 of FIG. 5 or after the operations associated with 5 of FIG. 5. The operations associated with 9 of FIG. 5 may occur at the same time as the operations associated with 10 of FIG. 5 or after the operations associated with 10 of FIG. 5.

A network device or function such as a UPF may be configured with ATSSS (e.g., including DualSteer) capabilities and may carry out one or more of the following operations associated with steering mode restrictions. The UPF may receive a session establishment request such as an N4 session establishment request that may include a steering mode policy (e.g., comprising a list of steering mode rules). Based on the steering mode policy, the UPF may check one or more validity conditions or restrictions associated with the steering mode rules to determine an initial steering mode rule. The UPF may follow the initial steering mode rule to split, switch, steer, and/or duplicate traffic (e.g., downlink traffic) across multiple access legs (e.g., two access legs under DualSteer). The UPF may follow a measurement configuration associated with the initial steering mode rule. The UPF may use the validity conditions to determine that another (e.g., higher priority) steering mode rule has become valid and may follow (e.g., switch to) the other (e.g., higher priority) steering mode rule to split, switch, steer, and/or duplicate traffic (e.g., downlink traffic) across the multiple access legs. The UPF may follow a measurement configuration associated with the other (e.g., higher priority) steering mode rule. The UPF may send a PMF message to a WTRU and may include information regarding the other (e.g., higher priority) steering mode rule in the message.

A network device or function such as a PCF may take actions to enable or support steering mode restrictions. The PCF may provide a steering mode policy (e.g., comprising a set of steering mode rules) to another network device or function such as an SMF. The PCF may determine the steering mode policy based on one or more of the following inputs. A first input may include requirements associated with a service data flow. These requirements may be received from an Application Function (AF), for example, A second input may include the steering mode capabilities of a WTRU, a third input may include the steering mode capabilities of a network device, and a fourth input may include one or more preferences of a network operator. For example, the network operator may have certain agreements with other operators and may favor using a specific access leg from those other operators. As another example, the network operator may want to push more traffic over an access leg that may be using an unlicensed spectrum. As yet another example, the network operator may want to push more traffic over an access leg that may be associated with a GEO, or over an access leg during certain times of the day. The input used by the PCF to determine the steering mode policy may also include one or more preferences of a WTRU that may be provided by the WTRU during a PDU session establishment procedure or a PDU session modification procedure. These preferences may be related to preferred RATs, non-preferred RATs, preferred frequency bands, non-preferred frequency bands, preferred PLMNs, non-preferred PLMNs, caps or limits on traffic over a certain access leg based on the WTRU's power, orientation, speed, etc.

The network device or function such as the PCF may perform one or more of the following to determine the steering mode policy. The PCF may receive requirements for a service data flow from an AF. The PCF may determine the steering mode capabilities of a WTRU. The PCF may receive preferences from a network operator related to the conditions under which the operator may prefer one access leg over another. The PCF may receive a PDU session establishment request, which may indicate a WTRU's preferences for one access leg over another. The PCF may determine the steering mode policy for the service data flow and provide the steering mode policy to another network function such as the SMF.

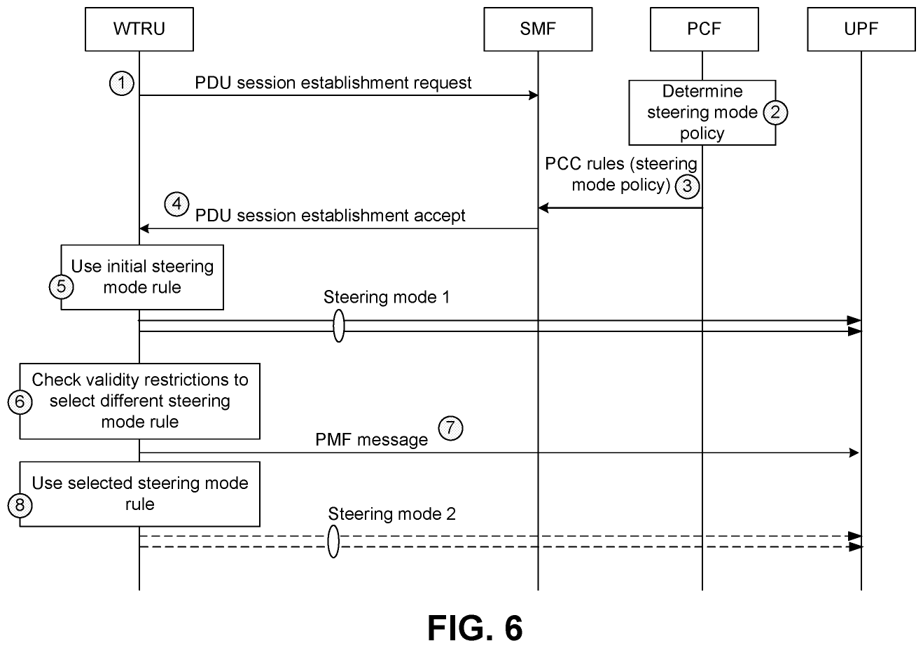

FIG. 6 illustrates examples of operations that may be performed by a WTRU and/or a network device with respect to steering mode rules and restrictions. As shown in FIG. 6, a WTRU may send, at 1, a PDU (e.g., a MA-PDU) session establishment request to a network (e.g., an SMF associated with the network) and the network (e.g., a PCF associated with the network) may determine, at 2, a steering mode policy, which may include a set of steering mode rules and/or their associated validity restrictions or conditions. At 3, the network (e.g., the PCF) may send the steering mode policy to the SMF (e.g., as part of policy and charging control (PCC) rules), which may forward the steering mode policy to the WTRU at 4 (e.g., in a PDU session establishment response that accepts the PDU session establishment request).

At 5 of FIG. 6, the WTRU may apply an initial or default steering mode rule (e.g., associated with steering mode 1) to split, switch, steer, and/or duplication traffic (e.g., uplink traffic) over at least one of multiple access legs. Subsequently, at 6, the WTRU may check one or more validity restrictions associated with the steering mode policy and select a different steering mode rule (e.g., associated with the steering mode 2) based on the validity restrictions and/or conditions at the WTRU. The WTRU may notify the network (e.g., an UPF associated with the network) about the newly selected steering mode rule, for example, by sending a PMF message to the UPF at 7 and may apply the newly selected rule at 8 to split, switch, steer, and/or duplicate traffic over at least one of the multiple access legs (e.g., the PMF message may be sent before or during the application of the newly selected steering mode rule).

Although features and elements described above are described in particular combinations, each feature or element may be used alone without the other features and elements of the preferred embodiments, or in various combinations with or without other features and elements. And although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU), comprising:
a processor configured to:
receive a first message from a network device, wherein the first message indicates at least one of a first rule and a second rule for performing uplink transmissions associated with a protocol data unit (PDU) session across a first network access leg and a second network access leg;
perform a first uplink transmission associated with the PDU session via at least one of the first network access leg or the second network access leg in accordance with the first rule;
determine that a condition for applying the second rule is satisfied; and
based on the determination that the condition for applying the second rule is satisfied, perform a second uplink transmission associated with the PDU session via at least one of the first network access leg or the second network access leg in accordance with the second rule.

17. The WTRU of claim 16, wherein the first rule indicates a first manner for steering, switching, splitting, or duplicating the uplink transmissions associated with the PDU session across the first network access leg and the second network access leg, and wherein the second rule indicates a second manner for steering, switching, splitting, or duplicating the uplink transmissions associated with the PDU session across the first network access leg and the second network access leg.

18. The WTRU of claim 16, wherein the first rule further indicates a validity condition for the first rule, and wherein the second rule further indicates a validity condition for the second rule.

19. The WTRU of claim 18, wherein the processor being configured to determine that the condition for applying the second rule is satisfied comprises the processor being configured to determine that the validity condition for the second rule has been satisfied.

20. The WTRU of claim 18, wherein the validity condition for the first rule or the second rule is associated with at least one of a time at the WTRU, a location of the WTRU, an orientation of the WTRU, a power of the WTRU, a traveling speed of the WTRU, a quality of experience (QoE) measurement associated with the WTRU, or a transmission mode of the WTRU.

21. The WTRU of claim 16, wherein the processor is further configured to transmit a second message to the network device that indicates that the WTRU is switching to the second rule.

22. The WTRU of claim 16, wherein the processor is further configured to transmit a session establishment request associated with the PDU session to the network device, wherein the session establishment request indicates a preference of the WTRU for at least one of the first network access leg or the second network access leg, and wherein the first message is received as a part of a PDU session establishment response from the network device.

23. The WTRU of claim 16, wherein the first network access leg is associated with a first cellular communication network and the second network access leg is associated with a second cellular communication network.

24. A method implemented by a wireless transmit/receive unit (WTRU), the method comprising:
receiving a first message from a network device, wherein the first message indicates at least one of a first rule and a second rule for performing uplink transmissions associated with a protocol data unit (PDU) session across a first network access leg and a second network access leg;
performing a first uplink transmission associated with the PDU session via at least one of the first network access leg or the second network access leg in accordance with the first rule;
determining that a condition for applying the second rule is satisfied; and
in response to determining that the condition for applying the second rule is satisfied, performing a second uplink transmission associated with the PDU session via at least one of the first network access leg or the second network access leg in accordance with the second rule.

25. The method of claim 24, wherein the first rule indicates a first manner for steering, switching, splitting, or duplicating the uplink transmissions associated with the PDU session across the first network access leg and the second network access leg, and wherein the second rule indicates a second manner for steering, switching, splitting, or duplicating the uplink transmissions associated with the PDU session across the first network access leg and the second network access leg.

26. The method of claim 24, wherein the first rule further indicates a validity condition for the first rule, wherein the second rule further indicates a validity condition for the second rule, and wherein determining that the condition for applying the second rule is satisfied comprises determining that the validity condition for the second rule is satisfied.

27. The method of claim 26, wherein the validity condition for the first rule or the second rule is associated with at least one of a time at the WTRU, a location of the WTRU, an orientation of the WTRU, a power of the WTRU, a traveling speed of the WTRU, a quality of experience (QoE) measurement associated with the WTRU, or a transmission mode of the WTRU.

28. The method of claim 24, further comprising transmitting a second message to the network device that indicates that the WTRU is switching to applying the second rule.

29. The method of claim 24, further comprising transmitting a session establishment request associated with the PDU session to the network device, wherein the session establishment request indicates a preference of the WTRU for at least one of the first network access leg or the second network access leg, and wherein the first message is received as a part of a PDU session establishment response from the network device.

30. The method of claim 24, wherein the first network access leg is associated with a first cellular communication network and wherein the second network access leg is associated with a second cellular communication network.
